(19) United States
(12) Patent Application Publication
(10) Pub. No.: US 2004/0218210 A1
(43) Pub. Date: Nov. 4, 2004

(54) Image processing apparatus

(75) Inventors: Toshiya Shozaki, Osaka (JP); Munehiro Nakatani, Amagasaki-shi (JP); Kenichi Takahashi, Osaka (JP); Kaitaku Ozawa, Amagasaki-shi (JP)

Correspondence Address: BURNS DOANE SWECKER & MATHIS L L P, POST OFFICE BOX 1404, ALEXANDRIA, VA, 22313-1404, US

(73) Assignee: KONICA MINOLTA BUSINESS TECHNOLOGIES, INC.

(21) Appl. No.: 10/720,161

(22) Filed: Mar. 23, 2004

(30) Foreign Application Priority Data
Mar. 25, 2003 (JP) 2003-82660

(51) Int. Cl. H04N 1/387; G06T 9/00; G06F 15/00

(52) U.S. Cl. 358/1.15; 358/450; 382/233; 382/240; 358/527

(57) ABSTRACT

Code data of a plurality of images are acquired from an external recording medium recording hierarchically encoded data of the plurality of images in the order of the unit of hierarchically encoding such as resolution. First, the code data is acquired only at a low level of the unit of hierarchical encoding from the external recording medium over the plurality of images, and the acquired code data are decoded. For example, an index print

This application is based on application No. 2003-82660 filed in Japan, the contents of which are hereby incorporated by reference.

### BACKGROUND OF THE INVENTION

1. Field of the Invention

The present invention relates to decoding of image data.

2. Description of Prior Art

In an apparatus which deals many images, it is often necessary to check the many images as a whole. Then, an index print is used wherein each of the selectable images is presented as small images in a sheet of paper. By observing the index print, a user can get the contents of the many images as a general view.

In an example of index print, after all the image data have been received, thumbnail images are generated from the received image data, and they are printed in a sheet of paper. However, the index printing cannot be started until all the thumbnail image data are received. Therefore, it takes a time until a user understands the general view on the images. In another example of index print, thumbnail images are prepared beforehand in a recording medium or in a computer, and they are sent to a printer for printing. In this method a user understands the general view on the images fast. However, printing of a selected single image is instructed after observing the index print, it is necessary to receive all the image data of the selected image.

If code data of images in a recording medium or in a computer are progressive data, it was proposed to send only images of low resolution for displaying a list of the images. For example, a facsimile apparatus described in Japanese Patent laid open Publication 6-152840/1994 can receive images stored in another facsimile apparatus. In order to display a list of the images to be received in a display device of the facsimile apparatus, the facsimile apparatus has a non-standard function to request to receive only images of the lowest resolution and their attribute data, in order to receive only necessary images among the images such as photographic pictures which take a long transmission time. Then, the user receives a list of the images and attribute data and selects necessary images in the list. When the selected images are notified to the another facsimile apparatus, it sends difference data for higher resolution only on the selected images. Therefore, unnecessary data transmission can be omitted.

When a document image read with a scanner, a multi-functional peripheral or the like is sent through a network to a user's terminal, compressed data of the images are sent to the terminal according to the setting at the side of the scanner or the like which stores the images. In such a case, when images of a document consisting of a plurality of images are received, it is desirable to provide an index of the images and a single picture early for the user.

In the above-mentioned facsimile apparatus described in Japanese Patent laid open Publication 6-152840, when requested by a user, an image of the list is sent. If the user does not select an image in the list, no data on higher resolution is sent, so that unnecessary data transmission is prevented. However, if the user wants to receive a single picture, it is further needed to select the image and request to receive the remaining data on the selected image. Further, the image cannot be shown until the data has been received completely.

### SUMMARY OF THE INVENTION

An object of the invention is to provide an index and a single picture when code data of a plurality of images are received.

In an image processing method, code data of a plurality of images are acquired from an external recording medium which records hierarchically encoded data of the plurality of images in the unit of hierarchically encoding. First the code data are acquired only at a low level of the unit of hierarchical encoding such as resolution from the external recording medium over the plurality of images. Then, the acquired code data are decoded. When instructed by a user, an index image is made on the plurality of images based on the data at a low level of the unit of hierarchical encoding. Data at high level of the unit of hierarchical encoding are continued for each of the plurality of images after the data acquisition of the data at a low level of the unit of hierarchical encoding is completed. If instructed by a user, an image is printed after data at the high level of the unit of hierarchical encoding is acquired for the image.

An advantage of the present invention is that an index print can be obtained at an early time.

Another advantage of the present invention is that printing of a single image becomes possible in a shorter time.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a block diagram of a system wherein an image file is outputted in a multiple functional peripheral;

FIG. 2 is a block diagram of a multi-functional peripheral;

FIG. 3 is a diagram of JPEG 2000 encoding in JPEG 200 codec;

FIG. 4 is a diagram of JPEG 2000 decoding in JPEG 200 codec;

FIG. 5 is a diagram for explaining data obtained by thrice wavelet conversion;

FIG. 6 is a diagram of arrangement of code data when resolution is prioritized;

FIG. 7 is a diagram of an example of panel display after starting to receive an image data and before completing to receive the data;

FIG. 8 is a diagram of a diagram of another example of panel display after starting to receive an image data and before completing to receive the data;

FIG. 9 is a diagram of a diagram of a further example of panel display after starting to receive an image data and before completing to receive the data;

FIG. 10 is a diagram of a result of index print;

FIG. 11 is a flowchart of data processing;

FIG. 12 is a flowchart of data processing of receiving data of higher layer after receiving data of lower layer;

FIG. 13 is a flowchart of monitoring;

FIG. 14 is a flowchart of changing a panel display;

FIG. 15 is a flowchart of acquiring data of low resolution;

FIG. 16 is a flowchart of acquiring data of high resolution;

FIG. 17 is a flowchart of data decoding;

FIG. 18 is a flowchart of generation of an index;

FIG. 19 is a flowchart of index printing;

FIG. 20 is a flowchart of print of a single image;

FIG. 21 is a diagram of a situation where data up to layer 0, 2 and 5 are outputted;

FIG. 22 is a diagram of an example on improvement of image quality by receiving data from a lower layer.

### DETAILED DESCRIPTION OF THE PREFERRED EMBODIMENTS

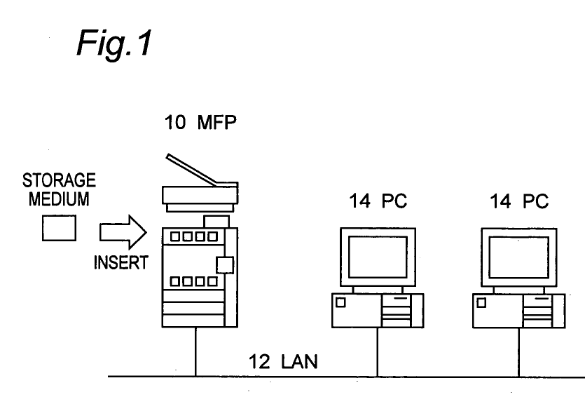

Referring now to the drawings, wherein like reference characters designate like or corresponding parts throughout the several views, FIG. 1 shows a system wherein image files are outputted by a multi-functional peripheral (hereinafter referred to as MFP) 10. The MFP 10 is an example of an image processing apparatus which receives and decodes code data of an image. It has a JPEG 2000 codec (or coder-decoder), and when an image file of JPEG 2000 is received, it is decoded and outputted. Personal computers 14 can be connected via a network such as a local area network 12 to the MFP 10, and a personal computer 14 can transfer an image data through the LAN 12 to the MFP 10. The MFP 10 has slots for various recording media.

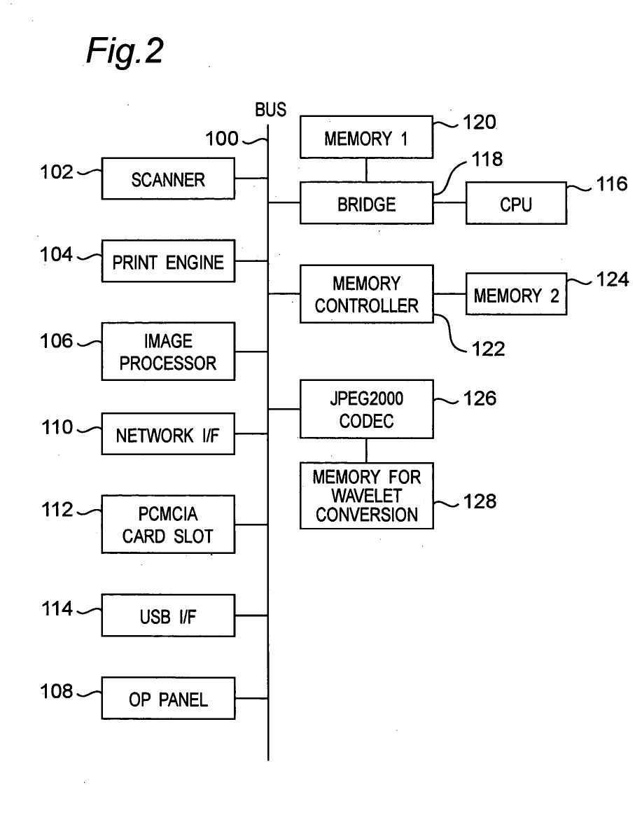

FIG. 2 is a block diagram of the MFP 12. Each block is connected via a bus 100 such as PCI bus. The MFP 12 has a scanner 102 for reading a document, a print engine 104 for printing, an image processor 106 for image data, and an operational panel 108 for the operation by a user. The operational panel 108 includes a display panel. Further, the MFP 12 has a network interface 110 such as network interface card, for receiving an image file, a personal computer memory card international association (PCMCIA) card clot 112 or a universal serial bus (USB) interface 114 for connection to an external storage device.

A central processing unit 116 (hereinafter referred to as CPU) is connected through a bridge 118 to a first memory device 120 and components connected to a bus 100 such as PCI bus. Image data or JPEG 2000 data received through the network interface 110, the PCMCIA card slot 112 or the USB interface 114 is transferred with direct memory access (DMA) to a second memory device 124 connected to a memory controller 122. The image data stored in the second memory 124 is transferred via DMA to a JPEG 2000 codec 126. The JPEG 2000 codec 126 encodes the image data to JPEG 2000 data with use of a memory device 128 for wavelet conversion or decodes JPEG 2000 data to image data. The image data obtained by the decoding is stored in the first memory device 120. The file stored in the first memory 120 is sent with DMA to the second memory 124 and stored therein.

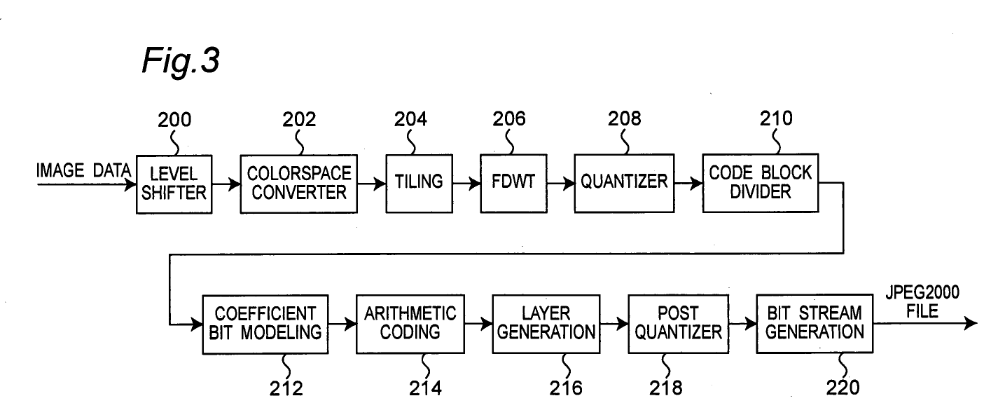

FIG. 3 shows a flow of JPEG 2000 encoding in the JPEG 2000 codec 126. This encoding (compression) is similar to the conventional encoding of JPEG 2000. A level shifter 200 decreases each color component of image data received in the JPEG 200 codec 126 to a half of its dynamic range (level shift). No level shift is performed if the input data has a sign such as color difference components of YCrCb data. Next, a color space converter 202 converts the color space of image data, and a tiling processor 204 divides the image data subjected to the color space conversion into blocks of a predetermined size. Next, an FDWT processor 206 performs discrete wavelet conversion for each tile to divide the image into a plurality of band regions. A quantizer 208 performs quantization on the image subjected to the wavelet conversion, if necessary. A code block divider 210 divides the data subjected to the wavelet conversion for each tile into code blocks, and a coefficient bit modeling processor 212 generates code paths with bit modeling. The generated code path is subjected to arithmetic encoding by an arithmetic encoder 214. A layer generator 216 divides the generated code data (compressed data) into a plurality of layers according to the degree of contribution to image quality. A post quantization processor 218 rounds data exceeding a predetermined amount of codes. Finally, a bit stream generator 220 generates a bit stream of the data and outputs a JPEG 2000 file thereof. The decoding at the apparatus which receives the JPEG 2000 file is performed in the reverse direction.

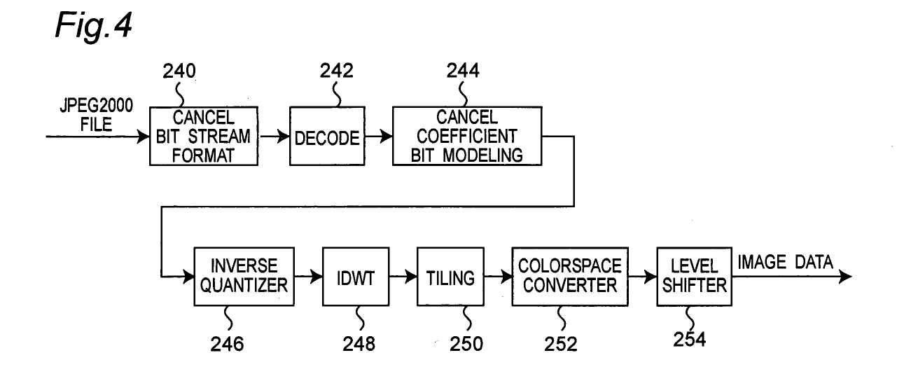

FIG. 4 shows a flow of decoding (expansion) of a JPEG 2000 file in the JPEG 2000 codec 126. This flow is the reverse to the encoding shown in FIG. 3. This decoding is similar to that of conventional JPEG 2000 decoding. A bit stream format canceler 240 cancels the bit stream format on the received bit stream data, and a decoder 242 decodes the data. Next, a coefficient bit modeling canceler 244 cancels the coefficient bit modeling, and an inverse quantizer 246 performs inverse quantization on the data received from the coefficient bit modeling canceler 244. Next, an inverse discrete wavelet transformer 248 performs inverse discrete wavelet transform, and a tiling processor 250 performs inverse tiling to provide image data of the original size. Next, a color space converter 252 performs inverse color space conversion to change the color space to that of the original color space, and finally, a level shifter 254 shifts the level of the image data to obtain the decoded image data.

Next, data acquisition and index printing are explained. When connection of a PCMCIA card or a storage device connected to the USB interface is detected, the CPU 116 checks the status of code data of JPEG 2000 files stored in the recording media. If the code data are found to be divided in the unit of hierarchical encoding such as resolution or layer, the code data are acquired successively from a low level to an upper level of hierarchical encoding and are subjected to JPEG 2000 decoding. The decoded data are stored in the memory device. Firstly, only the data at a low level of the unit of hierarchical encoding necessary to make an index are read in the image data of a document of a plurality of the images in the recording medium. When all the data of the low level of the unit of hierarchical encoding are received, it becomes possible to make an index print. Then, it is displayed in the display panel 108 that an index print is possible (refer to FIG. 8). The above-mentioned data of the low level of the hierarchical encoding necessary to make an index denotes data necessary to see what is the image generally, and it is also called as “low resolution data” or “low layer data” in the specification. When requested by a user, an index print is made by decoding the acquired data of low level of the unit of hierarchical encoding. Thus, the user can see generally the contents of the files in the recording medium at an early stage.

After all the code data at the low level of the unit of hierarchical encoding on all the images have been received, data of a hierarchical encoding level higher than the low level, called as “high resolution data” or “high layer data”, is received, and they are subjected to JPEG 2000 decoding. While an index is made, the code data are continued to be acquired in parallel. The code data at higher levels of hierarchical encoding is received in the unit of image. When decoding of an image is completed, the operational panel 108 displays the file name of the image with bold characters (refer to FIG. 9). Thus, a user can understand in the display device that it is possible to print the image. When a user instructs to output an image of file name shown with bold characters, the single image is outputted. Because the difference data are received while a user confirms the contents with reference to the index, a time until the single picture is outputted can be shortened.

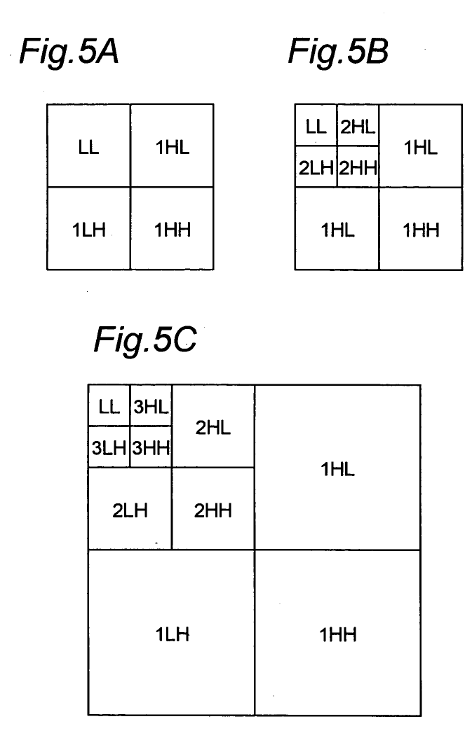

Next, decoding is explained in a case when the unit of hierarchical encoding is resolution. FIGS. 5A-5C show code data schematically when an image of a tile is subjected to wavelet conversion thrice. An image of a half size of the original image is obtained by one wavelet conversion. As shown in FIG. 5A, the entire image is converted to four code data of 1HL, 1LH, 1HH and LL, where LL denotes code data with a resolution of a half of the original image. In the second wavelet conversion, as shown in FIG. 5B, the code data LL is converted to four code data of 2HL, 2LH, 2HH and LL. In the third wavelet conversion, as shown in an enlarged view of FIG. 5C, the code data LL is converted to four code data of 2HL, 2LH, 2HH and LL.

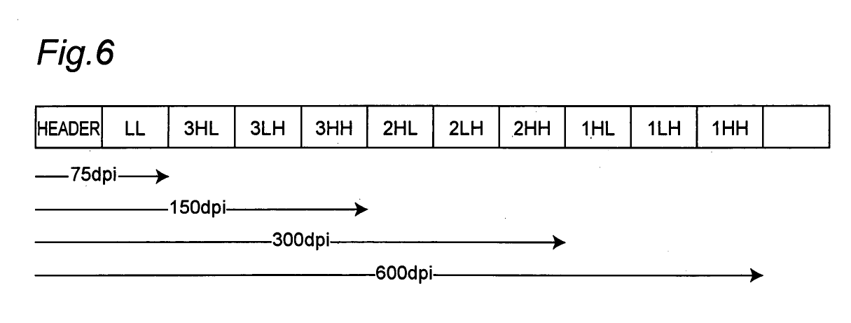

As shown in FIG. 6, a bit stream of code data of hierarchical encoding is divided according to the level of hierarchical encoding and is arranged in the order of LL, 3HL, 3LH, 3HH, 2HL, 2LH, 2HH, 1HL, 1LH and 1HH. If the resolution of the original image is 600 dots per inch (dpi), images of 300, 150 and 75 dpi are extracted by the thrice wavelet conversion. If an image of 75 dpi is desired, code data of LL is used. If an image of 150 dpi is desired, code data of LL, 3HL, 3LH and 3HH are used. If an image of 300 dpi is desired, code data of LL, 3HL, 3LH, 3HH, 2HL, 2LH and 2HH are used. If an image of 600 dpi is desired, all the code data are used. As shown in FIG. 6, by extracting the code data in the order of LL, 3HL, 3LH, 3HH, 2HL, 2LH, 2HH, 1HL, 1LH and 1HH, an image can be displayed in the order of resolution level of 75, 150, 300 and 600 dpi. In the index print explained below, “low resolution data” used for index print are code data of LL in this example. When code data of LL are acquired on all the images, index print is allowed.

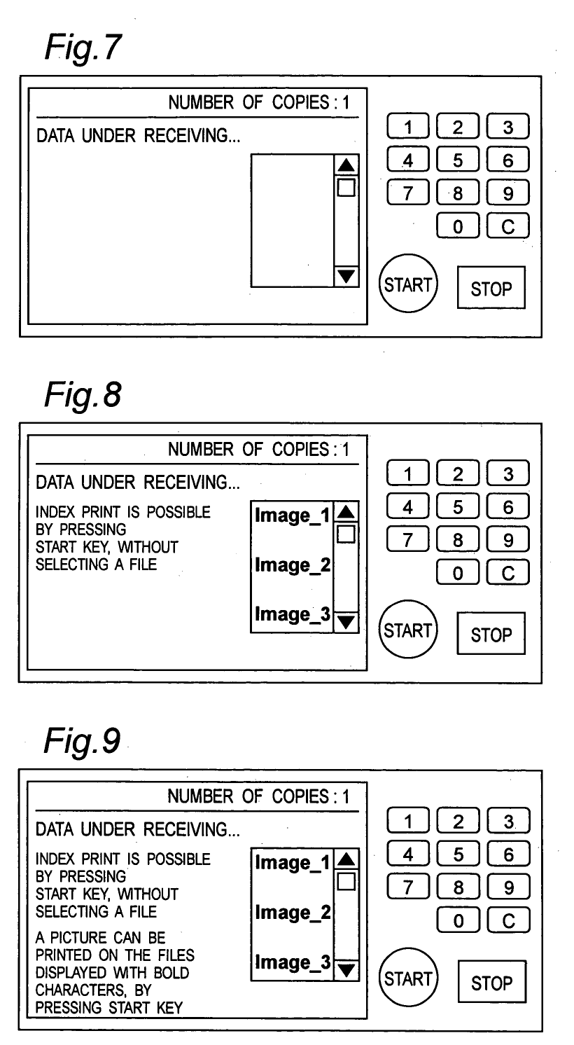

FIGS. 7 to 9 show examples of screens of the operational panel 108 while JPEG 2000 files are received. As mentioned above, as data of the files are received from the low hierarchical encoding level, the screen in the operational panel is changed successively according to the stage of data acquirement.

FIG. 7 shows the panel display when the data is started to be received. At the left side of the screen of the operational panel 108, a sentence of “data under receiving” is shown, while at the right side, names of received files are displayed in a window. At this stage no file name can be shown because data are just started to be received. As data of a file is completed to be received, the file name thereof is shown in the window. The window has a function of scrolling up and down when the number of the files to be displayed is too large to be displayed in the window.

FIG. 8 shows the panel display when all the data of low resolution has been received. At the left side of the screen, it is notified to a user that index print is possible because data of low level of the unit of hierarchical encoding has been received. Names of all the received files such as Image_1 in this example are displayed, but the file names are displayed with characters different from bold characters because no data at high resolution level is received. If start key provided in the operational panel is pressed, an index print is started.

At this stage, data of high resolution is received successively in the unit of file. The name of a file on which a single picture can be printed is displayed with bold characters, and this means that a single picture thereof can be printed. When a file name displayed with bold characters is selected by a user, backlight display is adopted (not shown), and when the start key is pressed, the single picture of the file is printed.

FIG. 9 shows a panel display when all the data have been received. At this time, all the file names are displayed with bold characters.

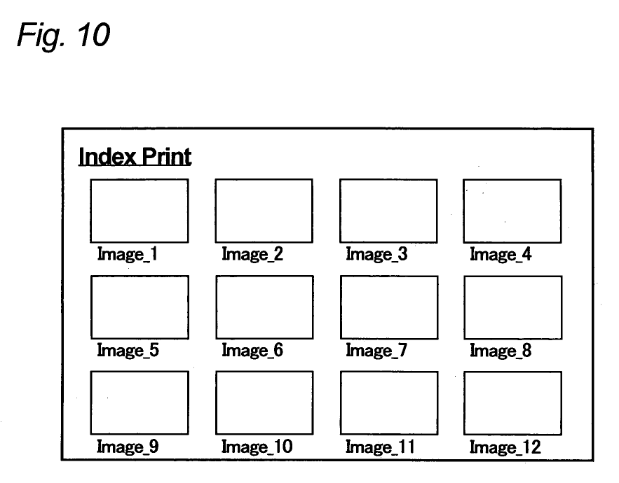

FIG. 10 shows an index print of 3*4 images which is a list of small pictures on the received images. A file name is printed before each picture, in order to make it easier to print a single picture. Though not shown, the index can also be shown similarly in a monitor connected to the MFP 10. The pictures are displayed in the order of the receive of the data of low resolution.

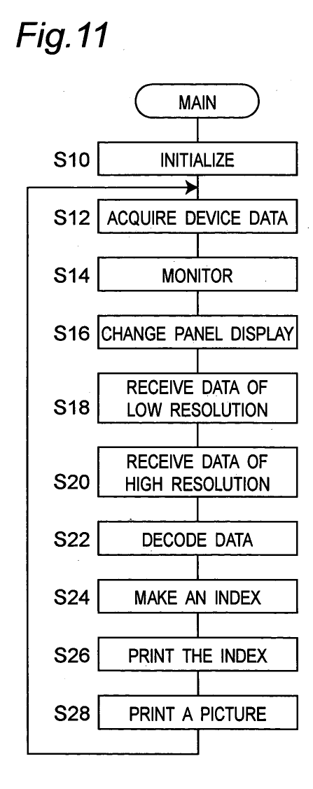

FIG. 11 shows a flowchart of the above-mentioned image processing of CPU 116. The program of the image processing is stored in the memory device 120. Data processing is started when a JPEG 2000 file is started to be sent from a computer 14 of a user, when a recording medium is inserted into the PCMCIA card slot 112 or when a storage device is connected to the USB interface 114. First, all the flags are initialized (S10) before receiving JPEG 2000 files.

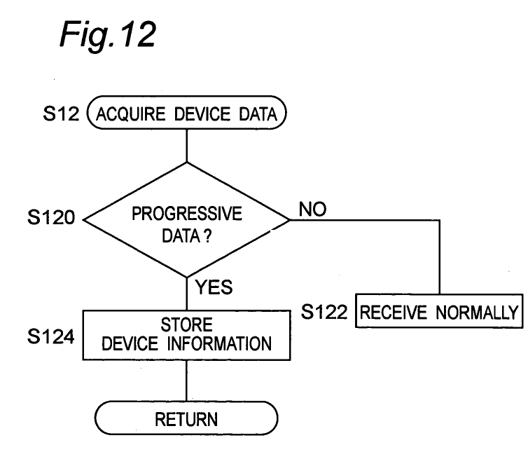

Next, device data are acquired (S12). As shown in FIG. 12, data on the files stored in the recording medium, the storage device or the like are analyzed, and it is checked whether the data to be acquired is progressive data or not (S120). If the data is not progressive data, the data is received normally (S122). If the data is progressive data, or if there is a data file of hierarchical encoding, the data on the files (including image ID) are stored in the storage device as device data (S124). Further, flag S is set to “1” in order to acquire data of low resolution on all the images.

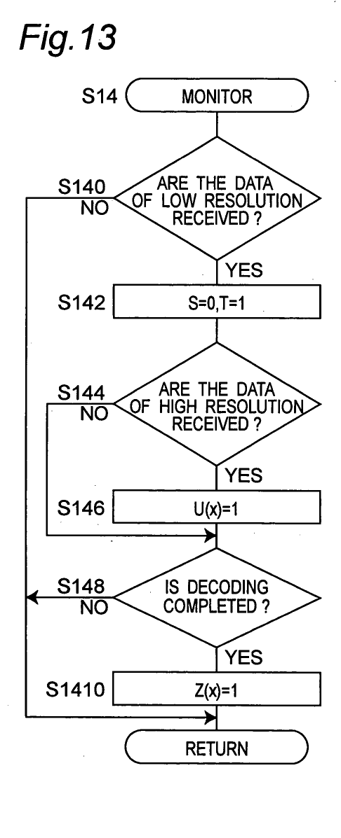

Next, the data transmission is monitored (S14). As shown in FIG. 13, signals of direct memory access are monitored, flags are set according to the signals. If all the data of low resolution of all the images have been received (YES at S140), flag S is set to “0” and flag “T” is set to 1 (S142). If an index print is made in correspondence to the flag S when the data of low resolution data have been received, an index print can be gotten at an early stage. The flag T is set to “1” in order to acquire data of high resolution. If the data of low resolution of all the images have not yet been received (NO at S140), the flow returns to the main routine. Next, the completion of the acquisition of data of high resolution is checked for each image (S144). If the data acquisition is completed, flag U(x) is set to “1” for the image (S146), wherein variable “x” represents image ID such as a number of 1, 2, 3, . . . . Next, it is checked for each image whether decoding of the data of high resolution is completed or not (S148). If the decoding is completed, flag Z(x) is set in correspondence to the image ID of the image on which the decoding is completed (S1410). If the decoding is not completed (NO at S148), the flow returns to the main routine.

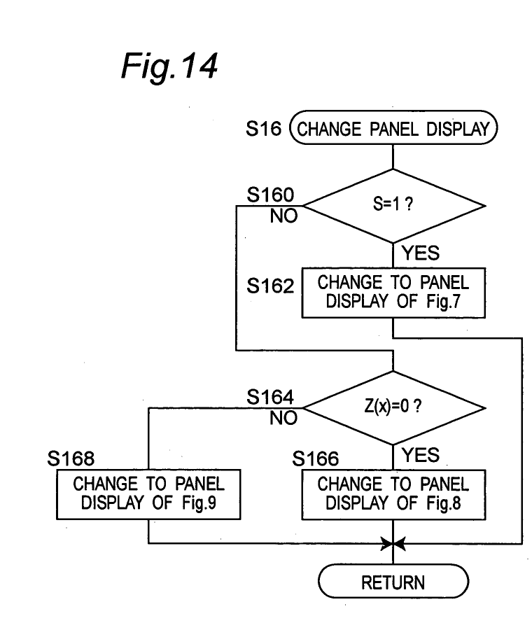

Next, the panel display is changed (S16). As shown in FIG. 14, if S=“1” or data of low resolution is under receiving (YES at S160), the panel shown in FIG. 7 is displayed (S162). If S=“0” or the data of low resolution has been received and if Z(x)=“0” (YES at S164), the panel shown in FIG. 8 is displayed (S166). At this stage, a comment is displayed that an index can be printed by pressing start key, without selecting a file. If Z(x)=“1” (NO at S164), the panel display is changed to display file names with bold characters for the files on which a single picture can be printed (S168). When all the data of low and high resolutions have been received, the panel display shown in FIG. 9 are displayed.

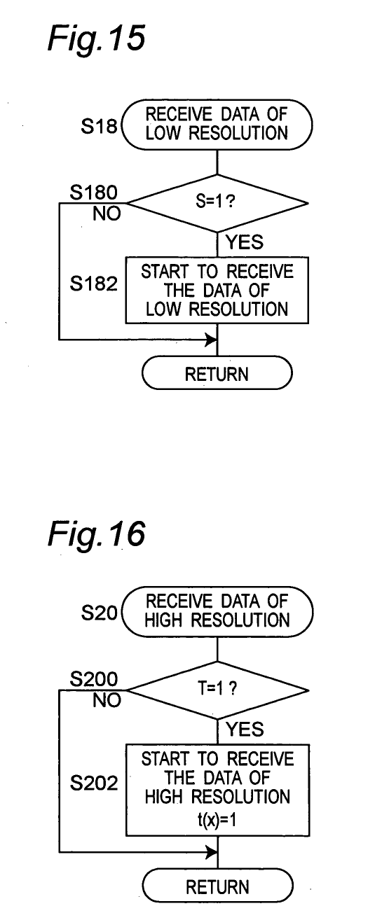

Next, the data of low resolution is received (S18). As shown in FIG. 15, if S=“1” (YES at S180), it is started to receive the data of low resolution of each image (S182). Then, the flow returns to the main routine. If S=“0” or the data of low resolution have been received (NO at S180), the flow returns to the main routine.

Next, the data of high resolution is received (S20). As shown in FIG. 16, if T=“1” (YES at S200), it is started to receive the data of high resolution of each image successively (S202). Then, the flow returns to the main routine. IF T=“0” or the data of high resolution have been received (NO at S200), the flow returns to the main routine.

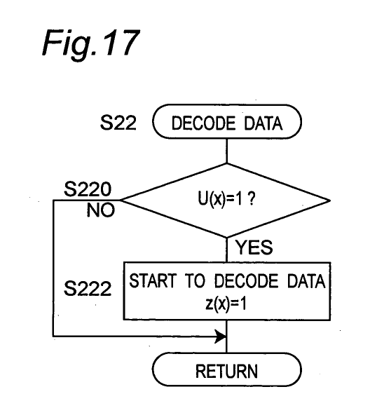

Next, the received data are decoded (S22). As shown in FIG. 17, if U(x)=“1” or the data of high resolution of an image with ID of x have been received (YES at S220), data decoding is started on the low and high resolutions of the image (S222). If U(x)=0 (NO at S220), the flow returns to the main routine.

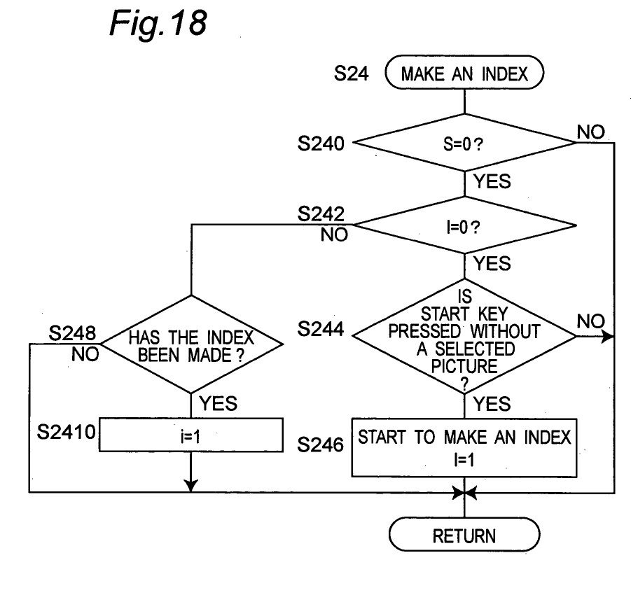

Next, an index is printed (S24). As shown in FIG. 18, if S=“0” or the data of low resolution is under receiving (NO at S240), the flow returns to the main routine. If S=“1” or the data of low resolution of all the images have been received (YES at S240), and if I=“0” or the index printing is waited to be started (YES at S242), it is checked next whether a user requests index print or not (S244). If the user presses the start key without selecting an image, this means a user requests index print. If index printing is requested, it is started, and the flag I is set to “1” (S246). IF index printing is not requested, the flow returns to the main routine. If a large screen is available, an image of the index can be displayed in the large screen.

If index printing is already started (NO at S242), it is decided next whether the index printing is completed or not (S248). If the index printing is completed, the flag i is set to “1” (S2410), and the flow returns to the main routine. If the index printing is not completed, the flow returns to the main routine.

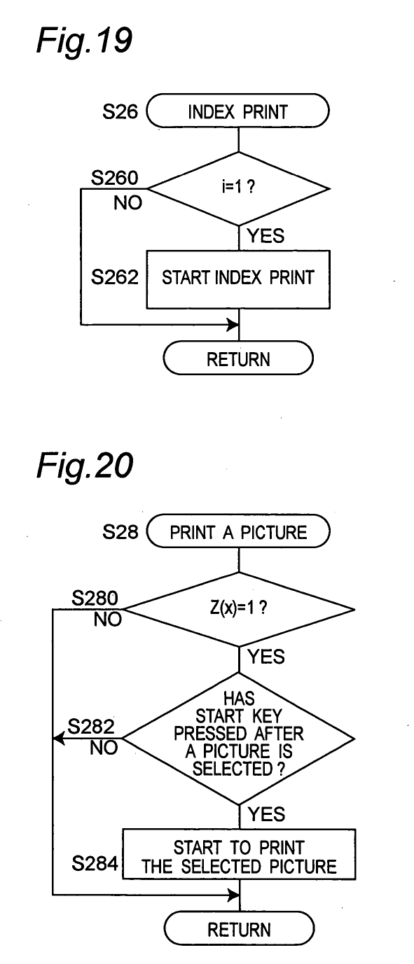

Next, the index printing is performed (S26). As shown in FIG. 19, if flag i=“1” or index printing had been completed (YES at S260), index printing is started (S262).

Next, a single picture is printed (S28). As shown in FIG. 20, it is checked whether Z(x)=“1” or there is data on which decoding is completed (S280). If there is no data on which-decoding is completed, the flow-returns to the main routine. If there is data on which decoding is completed, it is checked next whether the start key is pressed by a user without selecting a picture or whether printing of a single picture is requested (S282). If not requested, the flow returns to the main routine. If requested, the printing of a single picture is started, and the flow returns to the main routine.

As explained above, when a recording medium stores code data divided into a plurality of hierarchical encoding levels such as resolution on images, the program of the image processing executable by the CPU 116 has the steps of reading data first only at low level of the unit of hierarchical encoding such as resolution on a plurality of images, and after the data at low level of the unit of hierarchical encoding on the images have been received, reading data at a level of the unit of hierarchical encoding higher than the low level, such as high resolution data, is started for each image. Thus, the data only at the low level of the unit of hierarchical encoding are acquired first from the recording medium over the images.

Preferably, the program further comprises the steps of displaying in a display device that an index print is possible after the data at low level of the unit of hierarchical encoding on the images have been received, and of making an index image by decoding the acquired-data at low level of the unit of hierarchical encoding when instructed by a user.

Preferably, the program further comprises the steps of displaying in the display device that an image can be printed after data at a level of the unit of hierarchical encoding higher than the low level is acquired for the image, and of outputting the image based on the data acquired on the image when instructed by a user.

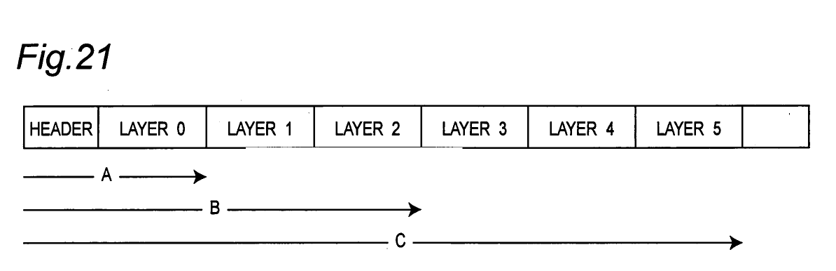

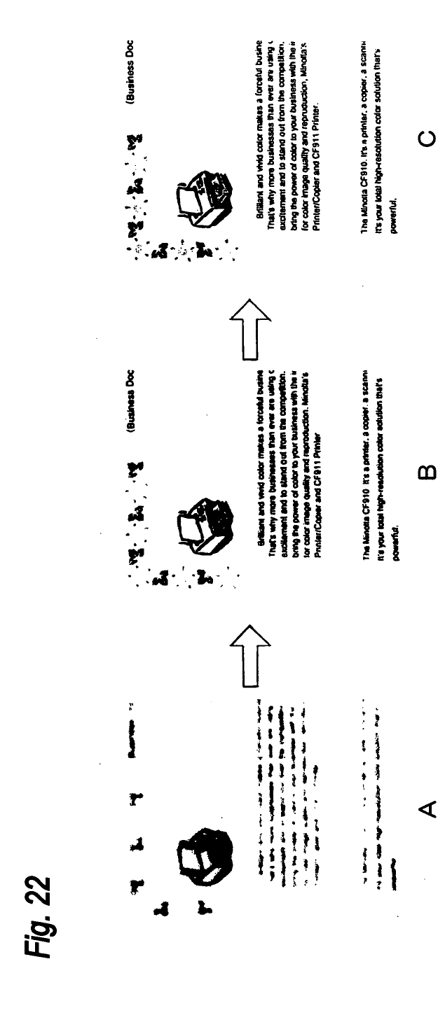

In the above-mentioned embodiment, processing based on resolution on JPEG 2000 files is explained. On the other hand, layer is used when scalability on image quality is realized. In a process for scalability on image quality, encoded data are divided into a plurality of layers according to the degree of contribution to image quality, and a bit stream is made in the order of layer. FIG. 21 shows a structure of such a bit stream data wherein code data has six layers. FIG. 22 shows examples of improvement of image quality when data are encoded to stages A, B and C.

As shown in FIG. 21, from the bit stream data of JPEG 2000 file received on each image, code data of each image is taken out in the order of header, layer 0, layer 1, layer 2, . . . , layer 5. Thus, the code data can be extracted in the order of image quality. Firstly, data of layer 0 is read on each image, and index print is allowed after the data of layer 0 on all the images are read from the recording medium. The term of “low layer data” means data on which an index can be made, and in this example, it is the data of layer 0. The unit of hierarchical encoding is layer in this embodiment. By reading the data of layer 0 every predetermined number of pixels for reduction, an index image consisting of the reduced images can be made. By combining high layer data other than the “low layer data” with the low layer data, image quality is improved successively. When data of all the layers is combined, the image quality of the original image is reproduced. The CPU can process the index printing on the low layer image similarly to that on the low resolution image, and its explanation is omitted here.

In the above-mentioned data acquisition from a recording medium, index printing becomes possible when data at low level of hierarchical encoding are received on all the images. Then, index printing can be started early.

Further, if a single picture is printed, it is not needed to request transmission on the data of the single picture because data are continuously received in parallel to the index printing. Thus, the single printing can be obtained in a shorter time.

In the above-mentioned embodiment, a JPEG 2000 file is processed in the MFP. However, any image processing apparatus having a JPEG 2000 codec on JPEG 2000 data can execute similar processing.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. An image processing apparatus which acquires code data of a plurality of images from an external recording medium recording hierarchically encoded data of the plurality of images in the unit of hierarchically encoding, the apparatus comprising:
an input interface which received signals from an external recording medium;
an input controller which acquires the code data by said input interface first only at a low level of the unit of hierarchical encoding from the external recording medium over the plurality of images;
a decoder which decodes the code data acquired by said input controller; and
a storage device which stores data decoded by said decoder.

2. The image processing apparatus according to claim 1, wherein the low level of the unit of hierarchical encoding is the lowest level.

3. The image processing apparatus according to claim 1, wherein said input controller acquires the code data first only at a plurality of levels including the lowest level of the unit of hierarchical encoding from the external recording medium over the plurality of images.

4. The image processing apparatus according to claim 1, further comprising a print engine which prints an image based on data decoded by said decoder.

5. The image processing apparatus according to claim 1, further comprising:
an index maker which makes an index image on the plurality of images based on the data at a low level of the unit of hierarchical encoding on the plurality of images;
a print engine which prints the index image received from said index maker;
an operational device which instructs to make an index to said index maker; and
a controller which allows to activate said index maker when instructed by said operational device after data acquisition of the data at a low level of the unit of hierarchical encoding is completed.

6. The image processing apparatus according to claim 5, wherein said image input controller continues to receive data at higher levels of the unit of hierarchical encoding for each of the plurality of images, after the data acquisition of the data at a low level of the unit of hierarchical encoding is completed.

7. The image processing apparatus according to claim 5, further comprising a display device which displays a state of data acquisition of the code data divided by levels of the unit of hierarchical encoding.

8. The image processing apparatus according to claim 5, further comprising a print engine which prints the index image received from said index make.

9. An image processing method for acquiring code data of a plurality of images from an external recording medium which records hierarchically encoded data of the plurality of images in the unit of hierarchically encoding, the method comprising the steps of:
acquiring the code data first only at a low level of the unit of hierarchical encoding from the external recording medium over the plurality of images; and
decoding the code data acquired from the external recording medium.

10. The image processing method according to claim 9, wherein the low level of the unit of hierarchical encoding is the lowest level.

11. The image processing method according to claim 9, wherein the code data is acquired first only at a plurality of levels including the lowest level of the unit of hierarchical encoding from the external recording medium over the plurality of images.

12. The image processing method according to claim 9, further comprising:
making an index image on the plurality of images based on the data at a low level of the unit of hierarchical encoding on the plurality of images;
receiving an instruction by a user to make an index; and
activating the step of making the index image when instructed by the user after data acquisition of the data at a low level of the unit of hierarchical encoding is completed.

13. The image processing method according to claim 12, further comprising the step of acquiring data at high level of the unit of hierarchical encoding for each of the plurality of images, after the data acquisition of the data at a low level of the unit of hierarchical encoding is completed.

14. The image processing method according to claim 12, further comprising the step of displaying a state of data acquisition of the code data divided by levels of the unit of hierarchical encoding.

15. A computer readable recording medium which records an image processing program for acquiring code data of a plurality of images from an external recording medium which records hierarchically encoded data of the plurality of images in the unit of hierarchically encoding, the program comprising the steps of:
acquiring the code data first only at a low level of the unit of hierarchical encoding from the external recording medium over the plurality of images; and
decoding the code data acquired from the external recording medium.

16. The computer readable recording medium according to claim 15, wherein the low level of the unit of hierarchical encoding is the lowest level.

17. The computer readable recording medium according to claim 15, wherein the code data is acquired first only at a plurality of levels including the lowest level of the unit of hierarchical encoding from the external recording medium over the plurality of images.

18. The computer readable recording medium according to claim 15, the program further comprising the steps of:
making an index image on the plurality of images based on the data at a low level of the unit of hierarchical encoding on the plurality of images;
receiving an instruction by a user to make an index; and
activating the step of making the index image when instructed by the user after data acquisition of the data at a low level of the unit of hierarchical encoding is completed.

19. The computer readable recording medium according to claim 18, the program further comprising the step of acquiring data at high level of the unit of hierarchical encoding for each of the plurality of images, after the data acquisition of the data at a low level of the unit of hierarchical encoding is completed.

20. The computer readable recording medium according to claim 18, the program further comprising the step of displaying that an image can be printed after data at the high level of the unit of hierarchical encoding is acquired for the image, and of outputting the image based on the data acquired on the image when instructed by a user.

21. The computer readable recording medium according to claim 18, the program further comprising the step of displaying a state of data acquisition of the code data divided by levels of the unit of hierarchical encoding.
